(19) United States
(12) Patent Application Publication
(10) Pub. No.: US 2005/0007207 A1
(43) Pub. Date: Jan. 13, 2005

(54) Nonreciprocal circuit device and telecommunications apparatus including the same

(76) Inventors: Eiichi Koma, Niigata-ken (JP); Hitoshi Onishi, Niigata-ken (JP)

Correspondence Address: BRINKS HOFER GILSON & LIONE, P.O. BOX 10395, CHICAGO, IL, 60610, US

(21) Appl. No.: 10/847,898

(22) Filed: May 18, 2004

(30) Foreign Application Priority Data
May 23, 2003 (JP) 2003-146426

(51) Int. Cl. H01P 1/36

(52) U.S. Cl. 333/24.2; 333/1.1

(57) ABSTRACT

A nonreciprocal circuit device includes a box-like yoke consisting of upper and lower yokes. The yoke accommodates a magnetic assembly consisting of a magnetic body and first to third line conductors, chip capacitors connected to ends of the line conductors, and a magnet. The first and second line conductors are input and output terminals, and an end of the third line conductor is connected to a terminating chip resistor. The chip resistor is longitudinally disposed such that its long sides are substantially perpendicular to a line between ends of the input and output terminals. The end of the third line conductor is connected to a terminal electrode on the hot side of the terminating chip resistor. A terminal electrode on the earth side of the terminating chip resistor is directly connected to the lower yoke, and a notch is formed in the lower yoke under the hot side terminal electrode.

This application claims the benefit of priority to Japanese Patent Application No. 2003-146426, herein incorporated by reference.

### BACKGROUND OF THE INVENTION

1. Field of the Invention

The present invention relates to a nonreciprocal circuit device including an isolator, which is used for telecommunications apparatuses, such as cell phones.

2. Description of the Related Art

FIG. 8 is an exploded perspective view of a typical isolator, which is one of known nonreciprocal circuit devices.

As shown in FIG. 8, an isolator 200 includes a box-like upper yoke 202 and a lower yoke 208, between which a circular permanent magnet plate 203, a magnetic assembly 205, a plastic case 207 accommodating three matching chip capacitors C1, C2, and C3 and a terminating chip resistor R are disposed (refer to U.S. Pat. No. 6,580,148 and U.S. Pat. No. 6,222,425).

The magnetic assembly 205 includes a circular ferrite plate 254 and three central conductors 251, 252, and 253, whose connecting portion has the same shape as the bottom surface of the ferrite plate 254. The ferrite plate 254 is disposed on the connecting portion of the central conductors 251, 252, and 253, which radially extend from the connecting portion at predetermined angles with respect to each other and are bent so as to wrap around the ferrite plate. Top ends of the central conductors 251, 252, and 253 have ports P1, P2, and P3, respectively, which extend outwardly from the ferrite plate. Although not shown, the central conductors 251, 252, and 253 are electrically insulated from each other by insulating sheets on the front surface of the ferrite plate.

The capacitors C1, C2, and C3 are respectively connected between the ports P1, P2, and P3 and an earth electrode inside the plastic case 207. The chip resistor R is connected between an electrode, which is connected to the port P3, and the earth electrode. The chip resistor R is transversely disposed such that the lengthwise sides are parallel to an imaginary line between the ports P1 and P2, which are used for input and output. A typical chip resistor R has a length of 0.6 mm and a width of 0.3 mm.

More specifically, as shown in FIG. 9, an electrode on the bottom surface of the chip capacitor C3, which is on the earth side, is soldered to an earth terminal 273, which is integrated into the bottom of the plastic case 207. The port P3 of the central conductor is soldered to a terminal electrode of the chip capacitor C3 and a terminal electrode on the hot side of the chip resistor R. A terminal electrode on the earth side of the chip resistor R is directly soldered to the lower yoke 208 to improve the power resistance.

In the isolator 200, a combination of the upper yoke 202 and the lower yoke 208 generates a magnetic circuit in conjunction with the permanent magnet plate 203, which can apply a bias magnetic field to the ferrite plate 254.

In the above-described structure, in which chip components are directly soldered to the lower yoke 208, a ball-shaped solder is sometimes confined in a narrow space between a terminal electrode connected to a port of a central conductor and the lower yoke 208 when a solder paste applied to the terminal electrode melts. To prevent this problem, as shown in FIGS. 8 and 9, a hole H is provided in the lower yoke 208. The hole H is formed at a position under the terminal electrode on the hot side of the chip resistor R. Therefore, a space around the terminal electrode on the hot side of the chip resistor R is open by the hole H when the above-described components are soldered. Consequently, melted solder is not left in the narrow space, thereby preventing a short circuit between the terminal electrode of the chip resistor R and the lower yoke 208 by the solder ball (refer to U.S. Pat. No. 6,580,148).

Alternatively, instead of forming the above-described hole in the lower yoke 208, a resin film may be formed on the lower yoke 208 at a position under the terminal electrode on the hot side of the chip resistor R, or a notch may be formed at the position and then the notch may be covered by a resin material.

Unfortunately, in a known isolator, the chip resistor R is transversely disposed, thus decreasing the length of the chip capacitor C3. This impairs miniaturization of the isolator.

Additionally, the hole H in the lower yoke 208 is located at the position under the terminal electrode on the hot side of the chip resistor R. This position is near the center of the lower yoke 208, namely, near the ferrite plate 254 and therefore a bias magnetic field from the upper and lower yokes to the ferrite plate 254 is affected. More specifically, a bias magnetic field applied to a side edge of the ferrite plate 254 in the vicinity of the hole H is decreased. Accordingly, a bias magnetic field is low at a point where the center conductor starts to wrap around the ferrite, thus disadvantageously increasing an insertion loss. If the size of the isolator is large, a large distance between the hole H and the ferrite plate 254 does not affect the bias magnetic field; however, as the isolator becomes smaller, the distance between a notch (the hole) and the ferrite plate 254 becomes shorter. Consequently, the bias magnetic field applied to the ferrite plate 254 is affected.

In recent years, demand for a compact isolator has been growing with reductions in size of mobile electronic devices. This problem prominently appears in compact isolators.

In addition, in the case where a resin film is formed on the lower yoke 208 at a position under the terminal electrode on the hot side of the chip resistor R, since the lower yoke 208 is normally plated with silver or solder, the resin film formed on such a plate film is easily removed, which is a problem.

### SUMMARY OF THE INVENTION

Accordingly, it is an object of the present invention to provide a compact nonreciprocal circuit device that prevents an increased insertion loss by applying a stable bias magnetic field to a magnetic body, and a telecommunications apparatus including the nonreciprocal circuit device.

A nonreciprocal circuit device according to the present invention includes a box-like yoke body consisting of an upper yoke and a lower yoke. The yoke body accommodates a magnetic body, three line conductors disposed on the magnetic body, a capacitive element connected to an end of each line conductor, and a magnet for applying a bias magnetic field to the magnetic body. The three line conductors are insulated with each other. Any two of the line conductors function as input and output terminals, and an end of the other line conductor being connected to a terminating chip resistor. The terminating chip resistor is longitudinally disposed such that its long sides are substantially perpendicular to a line between the ends of the input and output terminals. The end of the other line conductor is connected to a terminal electrode on the hot side of the terminating chip resistor, a terminal electrode on the earth side of the terminating chip resistor is directly connected to the lower yoke, and a notch or a hole is formed in the lower yoke at a position under the terminal electrode on the hot side of the terminating chip resistor.

In the nonreciprocal circuit device according to the present invention, the terminating chip resistor is longitudinally disposed, as described above, so that the chip capacitor connected to the end of the other line conductor can be advantageously longer. Additionally, since the terminal electrode on the hot side of the terminating chip resistor, which is longitudinally disposed as described above, is connected to the end of the other line conductor and the notch or the hole is formed in the lower yoke at a position under the terminal electrode on the hot side of the terminating chip resistor, a short circuit between the terminal electrode on the hot side of the terminating chip resistor and the lower yoke is prevented. In addition, since the notch or the hole is located in the vicinity of a corner of the lower yoke, the notch or the hole is located at a position far from the magnetic body. Consequently, the notch or the hole does not affect a bias magnetic field applied to the magnetic body, and therefore a stable bias magnetic field can be applied to the magnetic body.

Additionally, according to the present invention, when a size of a whole body of the device decreases, a distance between the magnetic body and the notch or the hole is relatively large. Therefore, a stable bias magnetic field can be applied to the magnetic body. This is suitable for a compact nonreciprocal circuit device.

Additionally, since the terminal electrode on the earth side of the terminating chip resistor is directly connected to the lower yoke, the nonreciprocal circuit device provides high power resistance.

As a result, the nonreciprocal circuit device according to the present invention can apply a stable bias magnetic field to the magnetic body and therefore can prevent increased insertion loss. Also, the whole body of the device can be miniaturized.

A nonreciprocal circuit device according to the present invention includes a box-like yoke body consisting of an upper yoke and a lower yoke. The yoke body accommodates a magnetic body, three line conductors disposed on the magnetic body, a capacitive element connected to an end of each line conductor, and a magnet for applying a bias magnetic field to the magnetic body. The three line conductors are insulated with each other. Any two of the line conductors function as input and output terminals, and an end of the other line conductor is connected to a terminating chip resistor. A terminal electrode on the hot side of the terminating chip resistor is disposed at a corner of the lower yoke, the end of the other line conductor is connected to the terminal electrode on the hot side of the terminating chip resistor, a terminal electrode on the earth side of the terminating chip resistor is directly connected to the lower yoke, and a notch or a hole is formed at the corner of the lower yoke.

In the nonreciprocal circuit device, the terminal electrode on the hot side of the terminating chip resistor, which is longitudinally disposed, is located at a corner of the lower yoke. The end of the other line conductor is connected to the terminal electrode on the hot side of the terminating chip resistor and the notch or the hole is formed at a corner of the lower yoke. Accordingly, the notch or the hole is located at a position far from the magnetic body. Thus, the notch or the hole does not affect a bias magnetic field applied to the magnetic body, and therefore a stable bias magnetic field can be applied to the magnetic body.

In the nonreciprocal circuit device according to the present invention, the overall size of the nonreciprocal circuit device is preferably less than or equal to 3.5 mm square.

Additionally, in the nonreciprocal circuit device according to the present invention, even if a length of the terminating chip resistor is 0.6 mm and a width of the terminating chip resistor is 0.3 mm, the above described direct connection between the terminal electrode on the earth side of the terminating chip resistor and the lower yoke provides high power resistance.

In the nonreciprocal circuit device according to the present invention, the terminal electrode on the hot side of the terminating chip resistor and the inner surface of the lower yoke are preferably insulated with a resin film. This further prevents a short circuit between the terminal electrode on the hot side of the terminating chip resistor and the lower yoke.

In the nonreciprocal circuit device according to the present invention, shapes of the line conductors on the magnetic body may be linear. However, the shapes having a bent portion, such as an eyebrow-shape, a zigzag shape, and a meandering shape, can increase the lengths of the line conductors on the magnetic body, and therefore can increase the inductance.

A telecommunications apparatus according to the present invention includes one of the above described nonreciprocal circuit devices according to present invention.

In this telecommunications apparatus, the nonreciprocal circuit device occupies only a small space, thus contributing to miniaturization of the whole body of the telecommunications apparatus.

### BRIEF DESCRIPTION OF THE DRAWINGS

FIG. 1 is a plan view of an isolator according to an embodiment of the present invention with part of the isolator removed;

FIG. 2 is a cross-sectional view taken along a line through a terminating chip resistor and a chip capacitor in the vicinity of a second port of the isolator according to the embodiment of the present invention;

FIG. 3 is a perspective view showing positions of a magnetic substrate, a lower yoke, and a terminating chip resistor of the isolator according to the present invention;

FIG. 4 is an exploded view of electrodes included in the isolator according to the present invention;

FIGS. 5A and 5B show an example of an electric circuit including the isolator according to the embodiment and a principle of operation of the isolator, respectively;

FIG. 6 shows a distribution of a bias magnetic field applied to a magnetic substrate of an isolator of Example 1;

FIG. 7 shows a distribution of a bias magnetic field applied to a magnetic substrate of an isolator of Comparative Example 1;

FIG. 8 is an exploded perspective view of a known isolator; and

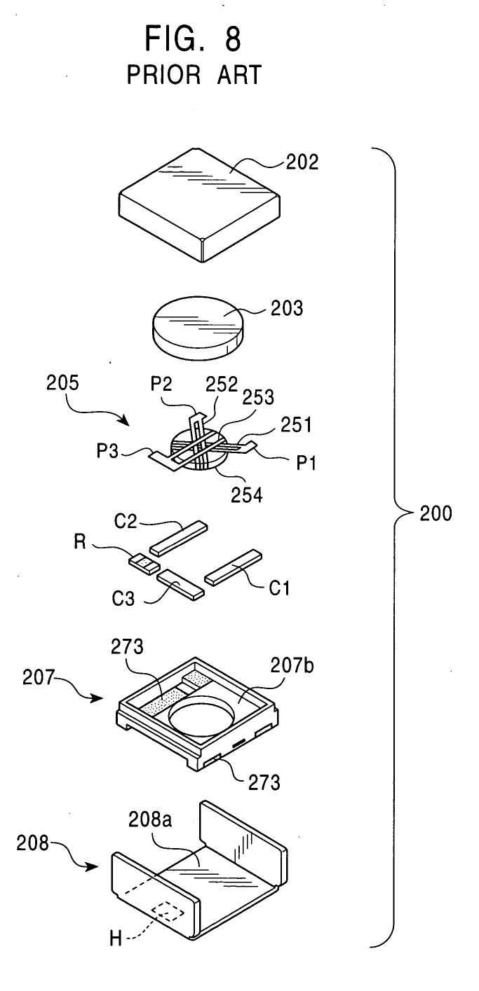

FIG. 9 is a partial cross-sectional view taken along a line through a terminating chip resistor R and a chip capacitor C3 of the known isolator.

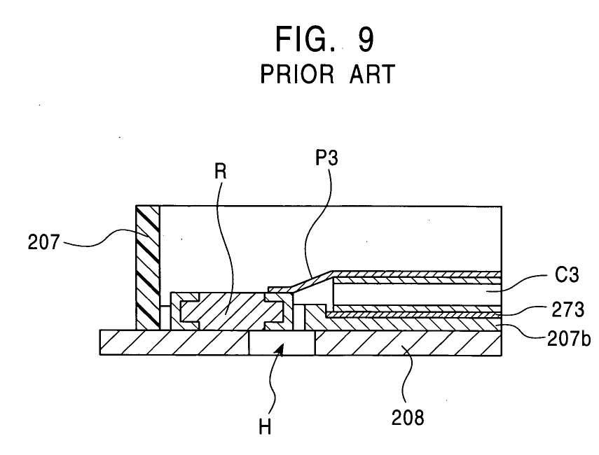

### DESCRIPTION OF THE PREFERRED EMBODIMENTS

Embodiments of the present invention will now be described in more detail.

Embodiments of Nonreciprocal Circuit Device

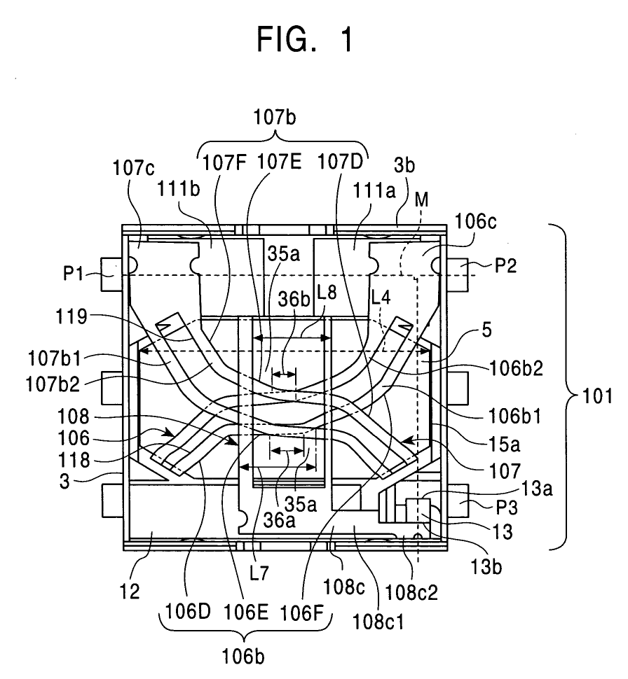

FIGS. 1 to 4 illustrate embodiments in which a nonreciprocal circuit device according to the present invention is applied as an isolator.

An isolator 1 according to an embodiment has a box-like yoke body consisting of an upper yoke 2 and a lower yoke 3, each of which has a U-shaped cross section. Inside the yoke body, a magnet 4, a magnetic substrate (magnetic body) 5, line conductors 106, 107, and 108, a common electrode 110 connected to the line conductors 106, 107, and 108, chip capacitors (capacitive elements) 12, 111a, 111b around the magnetic substrate 5, and a terminating chip resistor 13 are disposed.

The isolator 1 is substantially cubic, where the length and the width are about 3.5 mm or less and a height is about 1.6 mm or less. The isolator 1 has a center frequency of 1 GHz or less.

The upper yoke 2 and the lower yoke 3 are made of a ferromagnetic material, such as soft iron, and form a rectangular parallel piped case. The upper yoke 2 having a U-shaped cross section is fittable to the lower yoke 3 also having a U-shaped cross section. The upper yoke 2 fits in the lower yoke 3 to be integrated into one box-like body (a whole yoke body), which form a closed magnetic circuit in its interior.

The shape of the yokes 2 and 3 is not limited to a shape having a U-shaped cross section. For example, it may be any shape that forms a box-like closed magnetic circuit with a plurality of yokes.

Preferably, a conductive layer including Ag is coated on front and back surfaces of the yokes.

A space surrounded by the lower yoke 3 and the upper yoke 2 fitted together as described above, namely, a closed magnetic circuit formed by the lower yoke 3 and the upper yoke 2 accommodates a magnetic assembly 15, which is composed of the above-described magnetic substrate 5, the three line conductors 106, 107, and 108, and the common electrode 110 connected to the line conductors 106, 107, and 108. Thus, the isolator according to the embodiment includes the magnetic assembly 15.

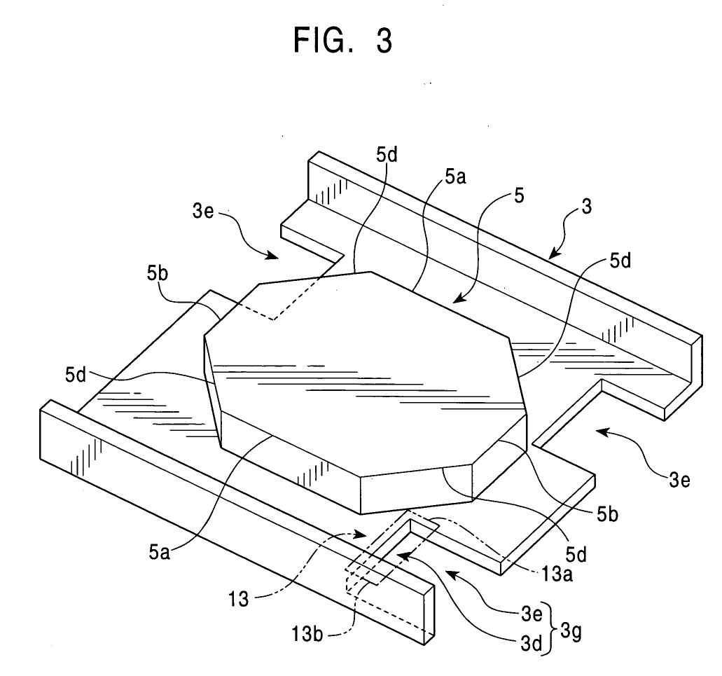

The magnetic substrate 5 is made of a ferromagnetic material, such as a ferrite. With reference to FIG. 3, the magnetic substrate 5 is a transversely long plate having a substantially rectangular shape in plan view. More specifically, the magnetic substrate 5 has two opposing transverse long sides 5a, two short sides 5b perpendicular to the long sides 5a, and four hypotenuses 5d extending from ends of the long sides 5a to ends of the short sides 5b, which are at an angle of 150 degrees with respect to the long sides 5a (at angle of 30 degrees with respect to extension lines of the long sides 5a). Consequently, at each of four corners of the magnetic substrate 5, an inclined plane (abutment plane), which inclines at an angle of 150 degrees to the long side 5a and inclines at an angle of 120 degrees to the short side 5b, is formed.

An aspect ratio of the magnetic substrate 5 is preferably between 0.25 (1:4) and 0.8 (4:5). That is, the magnetic substrate 5 is preferably transversely long. As used herein, “aspect ratio” refers to a ratio of the length in the transverse direction, namely, the lengthwise direction, to the length in the longitudinal direction, namely, the direction perpendicular to the lengthwise direction. The magnetic substrate 5 shown in FIG. 3 is transversely long; however, the magnetic substrate 5 is longitudinally long from a side view after FIG. 3 is rotated by 90 degrees. Therefore, in the present invention, a transversely long magnetic substrate 5 is equivalent to a longitudinally long magnetic substrate 5. Additionally, the shape of the magnetic substrate 5 is not limited to a substantially rectangular plate. The shape may be polygonal, such as hexagonal.

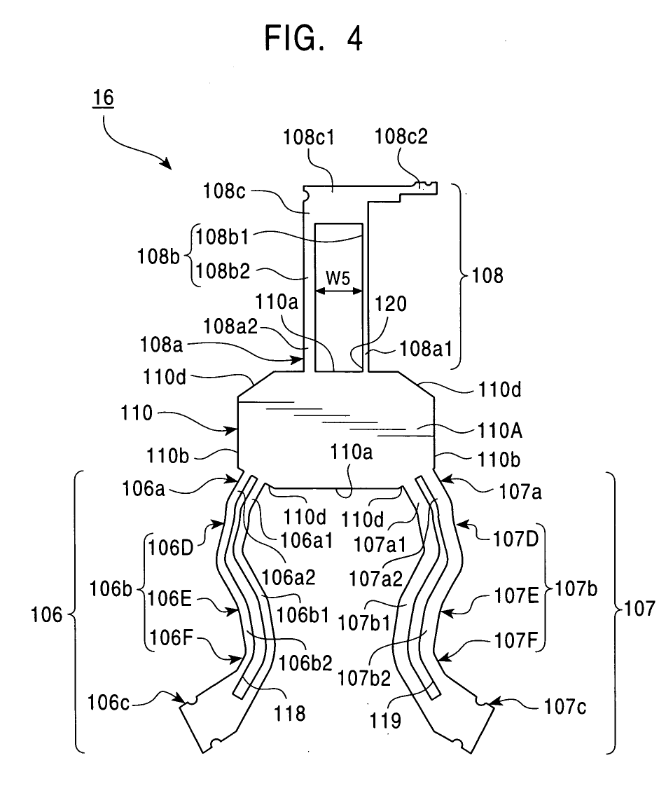

As shown in FIG. 4, the above-described three line conductors 106, 107, and 108 and the common electrode 110 are integrated. They are main parts of an electrode 16.

The common electrode 110 includes a main body 110A made from a metal plate having a substantially similar shape to that of the magnetic substrate 5 in plan view. That is, the main body 110A is substantially rectangular and has two opposing transverse long sides 110a, two short sides 110b perpendicular to the long sides 110a, and four hypotenuses 110d extending from ends of the long sides 110a to ends of the short sides 110b. Each hypotenuse 110d inclines at an angle of 150 degrees with respect to the adjacent long side 110a and inclines at an angle of 120 degrees to the adjacent short side 110b.

If the shape of the magnetic substrate 5 is polygonal, such as hexagonal, the shape of the common electrode 110 is also polygonal, such as hexagonal, in accordance with the shape of the magnetic substrate 5.

The first line conductor 106 and the second line conductor 107 extend from two hypotenuses 110d, which are two of the four hypotenuses 110d at the corners of the common electrode 110 and are located on both sides of one of the long side.

The first line conductor 106 extends from one of the two hypotenuses 110d. The first line conductor 106 consists of a first base conductor 106a, a first central conductor 106b, and a first top conductor 106c. On the other hand, the second line conductor 107 extends from the other one of the two hypotenuses 110d. The second line conductor 107 consists of a second base conductor 107a, a second central conductor 107b, and a second top conductor 107c.

The first central conductor 106b is meandering or zigzag shaped. The first central conductor 106b consists of three portions, which are an end portion 106D adjacent to the base conductor, an end portion 106F adjacent to the top conductor, and a central portion 106E between the two end portions. In particular, the central portion 106E of the first central conductor 106b is substantially eyebrow-shaped.

The second central conductor 107b has a similar shape to the first central conductor 106b. The second central conductor 107b consists of three portions, which are an end portion 107D adjacent to the base conductor, an end portion 107F adjacent to the top conductor, and an eyebrow-shaped central portion 107E between the two end portions.

A slit 118 is formed at the center of the first line conductor 106 in the width direction. The slit 118 divides the central conductor 106b into two conductor divisions 106b1 and 106b2 and also divides the base conductor 106a into two conductor divisions 106a1 and 106a2.

Like the slit 118, a slit 119 is formed at the center of the second line conductor 107 in the width direction. The slit 119 divides the central conductor 107b into two conductor divisions 107b1 and 107b2 and also divides the base conductor 107a into two conductor divisions 107a1 and 107a2.

In terms of the widths of the slits 118 and 119, the widths in the central portions 106E and 107E and the widths in the end portions 106F and 107F adjacent to the top conductors are greater that those in the end portions 106D and 107D adjacent to the base conductors of the first and the second central conductors 106b and 107b, respectively. That is, widths of parts of the slits 118 and 119 at the intersection between the first and the second central conductors 106b and 107b are greater than those of the end portions 106D and 107E. This width design allows an impedance matching with a power amplifier 45, which will be described below, to be appropriately determined without impairing characteristics of the isolator.

The widths of the conductor divisions 106b1 and 106b2 of the first central conductor 106b are smaller than those of the conductor divisions 107b1 and 107b2 of the second central conductor 107b. This design prevents impedance mismatching with the power amplifier 45 caused by the first central conductor 106b wound at a closer location to the magnetic substrate 5 than the second central conductor 107b. Thus, superior impedance matching can be achieved.

On the other hand, the third line conductor 108 extends from a center of the other long side 110a of the common electrode 110. The third line conductor 108 consists of a third base conductor 108a, a third central conductor 108b, and a third top conductor 108c. The third base conductor 108a consists of two rectangular conductor divisions 108a1 and 108a2, which extend substantially perpendicularly from the center of the long side of the common electrode 110. A slit 120 is formed between the two conductor divisions 108a1 and 108a2. One conductor division 108a2 is wider than the other conductor division 108a1.

The third central conductor 108b consists of a substantially linear conductor division 108b1 coupled with the conductor division 108a1 and a substantially linear conductor division 108b2 coupled with the conductor division 108a2. The slit 120 is disposed between the conductor divisions 108b1 and 108b2 . One conductor division 108b2 is wider than the other conductor division 108b1.

In addition, top ends of the conductor divisions 108b1 and 108b2 are coupled with the L-shaped third top conductor 108c.

The third top conductor 108c consists of a connection segment 108c1, which couples the conductor divisions 108b1 and 108b2 together and extends in the same direction as the conductor divisions 108a1 and 108a2, and a connection segment 108c2 extending substantially perpendicularly to the connection segment 108c1.

In the electrode 16, the main body 110A of the common electrode 110 is attached to a second surface (one surface) of the magnetic substrate 5. Then, the first line conductor 106, the second line conductor 107, and the third line conductor 108 are bent to a first surface (the other surface) side of the magnetic substrate 5 to wrap around the magnetic substrate 5, thus achieving the magnetic assembly 15.

The first and second central conductors 106b and 107b extend along the surface of the magnetic substrate 5 to intersect each other on the first surface (the other surface) of the magnetic substrate 5. FIG. 1 shows the central portion 106E overlapping the central portion 107E.

Additionally, the meandering or zigzag shapes of the first and second central conductors 106b and 107b allow lengths thereof on the first surface (the other surface) of the magnetic substrate 5 to be more than 5% longer than lengths of straight central conductors, namely, a direct distance between the opposing hypotenuses 5d. The longer lengths of the first and the second line conductors on the magnetic substrate can increase the inductance of the isolator. Accordingly, a compact isolator having low operating frequency can be advantageously fabricated.

In this embodiment, as shown in FIG. 1, the length of overlap of the first central conductor 106b and the second central conductor 107b at an intersection 35a refers to a length L7 of overlap of the conductor division 106b1 of the central portion 106E and the conductor division 107b1 of the central portion 107E, or a length L8 of overlap of the conductor division 106b2 of the central portion 106E and the conductor division 107b2 of the central portion 107E. In this case, the length L7 or L8 is preferably greater than or equal to 10% of a length L4, which is the length of each central conductor on the first surface (the other surface) of the magnetic substrate 5. This length increases the capacitance maintained at the overlap of the first and second central conductors 106b and 107b, and therefore reduces capacitances of capacitors connected to the line conductors. Accordingly, a required space for the capacitors can be reduced while maintaining the same capacitance. More preferably, the length L7 or L8 is greater than or equal to 20% of L4.

Within the overlap of the conductor divisions 106b1 and 107b1, non-parallel segments exist as well as parallel segments 36a. Also, within the overlap of the conductor divisions 106b2 and 107b2, non-parallel segments exist as well as parallel segments 36b. The length of the parallel segments 36a preferably ranges from about 20% to about 100% of the length L7 of overlap of the conductor divisions. The length of the parallel segments 36b preferably ranges from about 20% to about 100% of the length L8 of overlap of the conductor divisions.

A length of the parallel segments 36a smaller than 20% of the length L7 of overlap of the conductor divisions, namely, a ratio of length of the parallel segments 36a to L7 smaller than 20% increases the insertion loss, which is not preferable. Further, a length of the parallel segments 36b smaller than 20% of the length L8 of overlap of the conductor divisions, namely, a ratio of a length of the parallel segments 36b to L8 smaller than 20% increases the insertion loss, which is not preferable.

In this embodiment, the crossing angle between the first central conductor 106b and the second central conductor 107b at an intersection 35a thereof refers to a crossing angle between the conductor division 106b1 of the central portion 106E and the conductor division 107b1 of the central portion 107E, or a crossing angle between the conductor division 106b2 of the central portion 106E and the conductor division 107b2 of the central portion 107E at the overlap point. In this case, the crossing angle is preferably smaller than or equal to 30 degrees and, more preferably, is smaller than 15 degrees. In the case where the parallel segments 36a exists in the overlap of two conductor divisions, as in this embodiment, a crossing angle between the two conductor divisions is a degree of zero or substantially zero in the parallel segments 36a, and a crossing angle between the two conductor divisions in the non-parallel segments is preferably smaller than or equal to 30 degrees. A crossing angle between the two conductor divisions in the non-parallel segments greater than 30 degrees increases the insertion loss, which is not preferable.

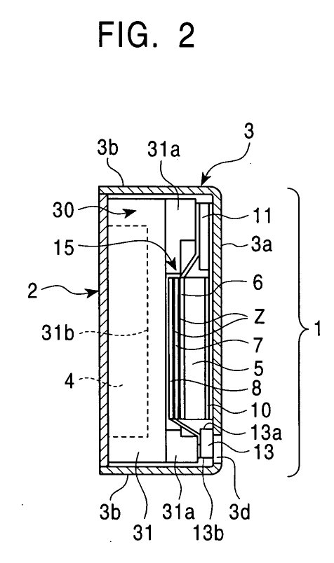

Although not shown in FIG. 1, with reference to FIG. 2, insulating sheets Z are respectively disposed between the magnetic substrate 5, the first line conductor 106, the second line conductor 107, and the third line conductor 108 so that the line conductors 106, 107, and 108 are electrically insulated to each other. The first line conductor 106 and the second line conductor 107 function as input and output terminals.

The magnetic assembly 15 is centrally disposed on the bottom of the lower yoke 3. The lower yoke 3 accommodates a chip capacitor 12 on one side of the magnetic assembly 15 and chip capacitors 111a and 111b on the other side. The lower yoke 3 also accommodates the terminating chip resistor 13 on one side of the chip capacitor 12. The terminating chip resistor 13 is preferably 0.6 mm in length and 0.3 mm in width. The terminating chip resistor 13 is longitudinally disposed, substantially perpendicularly to a line M between the top conductor 106c of the line conductor 106 and the top conductor 107c of the line conductor 107 or a line between the first port P1 and the second port P2, which will be described below.

The top conductor 106c of the first line conductor 106 is electrically connected to an electrode formed in the chip capacitor 111a, while the top conductor 107c of the second line conductor 107 is electrically connected to an electrode formed in the chip capacitor 111b.

The top conductor 108c of the third line conductor 108 is electrically connected to the chip capacitor 12 and a terminal electrode on the hot side of the terminating chip resistor 13. A terminal electrode 13a on the earth side of the terminating chip resistor 13 is directly connected to the lower yoke 3.

With reference to FIG. 3, the lower yoke 3 has a notch 3d at a position under a terminal electrode 13b on the hot side of the terminating chip resistor 13. The notch 3d is located at a corner of the lower yoke 3. That is, the terminal electrode 13b on the hot side of the terminating chip resistor 13 is positioned at a corner of the lower yoke 3.

Also, the lower yoke 3 has three port-engaging notches 3e with which the ports P1, P2, and a port P3 are engaged. The ports P1, P2, and P3 will be described below. Among these notches for the ports, a notch 3e with which the third port P3 is engaged and the notch 3d under the hot side of the terminating chip resistor 13 are joined together to form one notch 3g.

The terminal electrode 13b on the hot side of the terminating chip resistor 13 and the interior of the lower yoke 3 is electrically insulated with a resin film (not shown).

The first port P1 of the isolator 1 is disposed at an end of the chip capacitor 111b to which the second top conductor 107c is connected. The second port P2 of the isolator 1 is disposed at an end of the chip capacitor 111a to which the top conductor 106c is connected. The third port P3 of the isolator 1 is disposed at an end of the terminating chip resistor 13 to which the top conductor 108c is connected.

The thickness of the magnetic assembly 15 is about a half of the height of a space formed by the lower yoke 3 and the upper yoke 2. A space between the magnetic assembly 15 and the upper yoke 2 accommodates a spacer 30 shown in FIG. 2. A magnet 4 is mounted on the spacer 30.

The spacer 30 consists of a rectangular base plate 31 having a size that fits in the interior of the upper yoke 2 and legs 31a formed on four corners of the back face of the base plate 31. On the top face of the base plate 31, which is the side where the legs 31a are not disposed, a circular storage recess 31b is formed. A rectangular through-hole (not shown) is formed in the base plate 31 at the bottom of the storage recess.

The magnet 4 made of a permanent magnet is fitted in the storage recess 31b. The legs 31a of the spacer 30 having the magnet 4 push down, onto the bottom of the lower yoke 3, the chip capacitors 111a, 111b, and 12, the top conductors 106c and 107c connected to the chip capacitors, the terminating chip resistor 13, and the top conductor 108c connected to the terminating chip resistor 13. Thus, the magnetic assembly 15 is accommodated between the upper yoke 2 and the lower yoke 3 with the spacer 30 urging the magnetic assembly 15 onto the lower yoke 3.

The magnet 4 is used for applying a bias magnetic field to the magnetic substrate 5. The magnet 4 is rectangular in plan view. More specifically, the magnet 4 is a transversely long rectangular plate having two opposing long sides and two short sides perpendicular to the long sides.

The magnet 4 is larger than the magnetic substrate 5. More specifically, in a projected drawing of the magnet 4 and the magnetic substrate 5 disposed in the upper yoke 2 and the lower yoke 3 viewed from the lower case, that is, in plan view, the magnet 4 has overhangs which extend past at least one of the sides of the magnetic substrate 5.

In the isolator 1 according to the embodiment shown in FIGS. 1 to 4, the first line conductor 106 and the second line conductor 107 are bent to the first surface of the magnetic substrate 5 to wrap around it, as described above. Therefore, a signal from an input line conductor can be efficiently transferred to an output side, thereby exhibiting a low-loss and a wide frequency range of propagation characteristics. As a result, superior magnetic characteristics of the magnetic assembly 15 can be reliably achieved.

In the isolator 1 according to the embodiment, the terminating chip resistor 13 is longitudinally disposed so that the chip capacitor 12 connected to an end of the third line conductor 108 can be advantageously longer.

Additionally, since the terminal electrode 13b on the hot side of the terminating chip resistor 13, which is longitudinally disposed as described above, is connected to the end of the third line conductor 108 and the notch 3d is formed in the lower yoke 3 at a position under the terminal electrode 13b on the hot side of the terminating chip resistor 13, a short circuit between the terminal electrode 13b on the hot side of the terminating chip resistor 13 and the lower yoke 3 is prevented. In addition, since the notch 3d is located at a corner of the lower yoke 3, the notch 3d is located at a position far from the magnetic substrate 5. Consequently, the notch 3d does not affect a bias magnetic field applied to the magnetic substrate 5, and therefore a stable bias magnetic field can be applied to the magnetic substrate 5.

Since the terminal electrode 13a on the earth side of the terminating chip resistor 13 is directly connected to the lower yoke 3, heat can be dissipated through the lower yoke 3, thus providing high power resistance.

Since the terminal electrode 13b on the hot side of the terminating chip resistor 13 and the lower yoke 3 are insulated with a resin film therebetween, a short circuit between the terminal electrode 13b and the lower yoke 3 is efficiently prevented.

As a result, the isolator 1 according to the embodiment can apply a stable bias magnetic field to the magnetic substrate 5 and therefore can prevent increased insertion loss. Also, the whole body of the device can be miniaturized.

In the above-described embodiment, slits are formed in the first and second line conductors 106 and 107 connected to input and output terminals. However, the first and second line conductors 106 and 107 need not have slits.

The first and second line conductors without slits increase inductance compared with generating conductor divisions by the slits. Therefore, this structure is advantageous for fabricating a compact isolator having a low center frequency of 1 GHz or less that requires large inductance.

In the above-described embodiment, the first and second line conductors have bent portions in their central conductors. However, the central conductors may be linear.

In the above-described embodiment, the magnet 4, the magnetic substrate 5, and the common electrode 110 are transversely long and substantially rectangular plates. However, a magnet, a magnetic substrate, and a common electrode may have, for example, another quadrangular, polygonal, or circular shape. Also, they may be longitudinally long or transversely long. The shapes of a magnet, a magnetic substrate, and a common electrode may be the same or different from each other.

In the above-described embodiment, the isolator having a center frequency of 1 GHz or less is used. However, the present invention can be applied to an isolator having a center frequency in the range of between 1.44 GHz and 1.9 GHz.

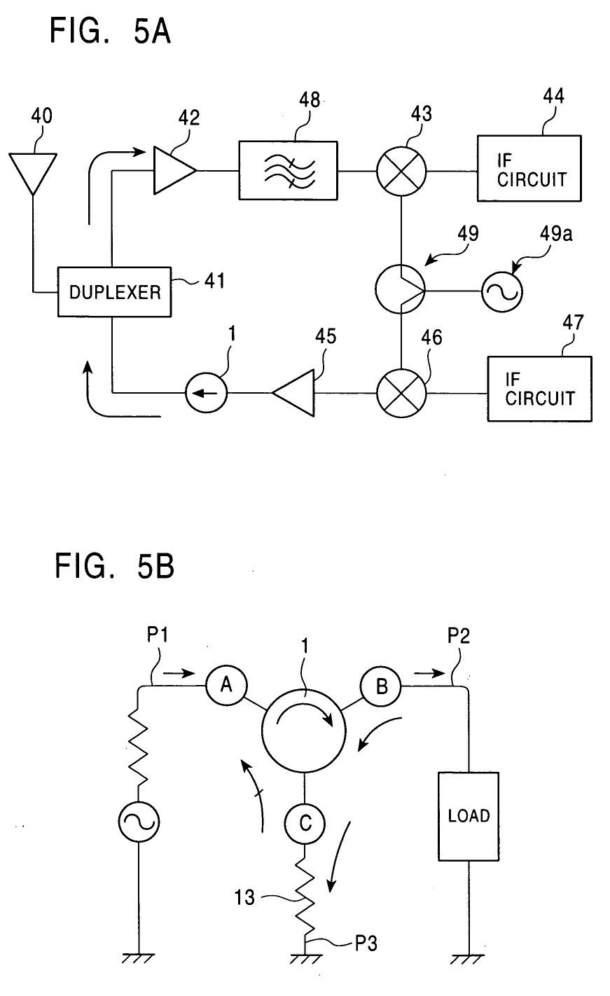

FIG. 5A shows an example of a circuit configuration of a cell phone (telecommunications apparatus) incorporating the isolator 1 according to the above-described embodiment. In this circuit configuration, an antenna 40 is connected to an antenna splitter (duplexer) 41, an output contact point of the duplexer 41 is connected to a low noise amplifier 42, which is connected to a reception circuit (IF circuit) 44 via an interstage filter 48 and a selection circuit (mixing circuit) 43. An input contact point of the duplexer 41 is connected to a transmission circuit (IF circuit) 47 via the isolator 1 according to the above-described embodiment, a power amplifier 45, and a selection circuit (mixing circuit) 46. The selection circuits 43 and 46 are connected to a local oscillator 49a via a distribution transformer 49.

The isolator 1, which is incorporated in a circuit of a cell phone shown in FIG. 5A, allows signals from the isolator 1 to the duplexer 41 to pass through with low loss, but shuts off signals in the reverse direction by increasing the loss. Thus, the isolator 1 has reverse input protection to prevent unnecessary signals of the power amplifier 45, such as noise, from turning back to the power amplifier 45.

FIG. 5B shows a principle of operation of the isolator 1 shown in FIGS. 1 to 4. The isolator 1 in a circuit shown in FIG. 5B allows a signal to pass through from a first-port P1 side A to a second-port P2 side B, but absorbs a signal from the side B to a third-port P3 side C by attenuating the signal with a terminating resistor 13 and shuts off a signal from the side C to the side A.

Accordingly, the isolator 1 included in the circuit shown in FIG. 5A can provide the above-described advantage.

### EXAMPLES

The present invention will now be described with reference to examples in detail. However, the present invention is not limited to the examples described below.

### First Example

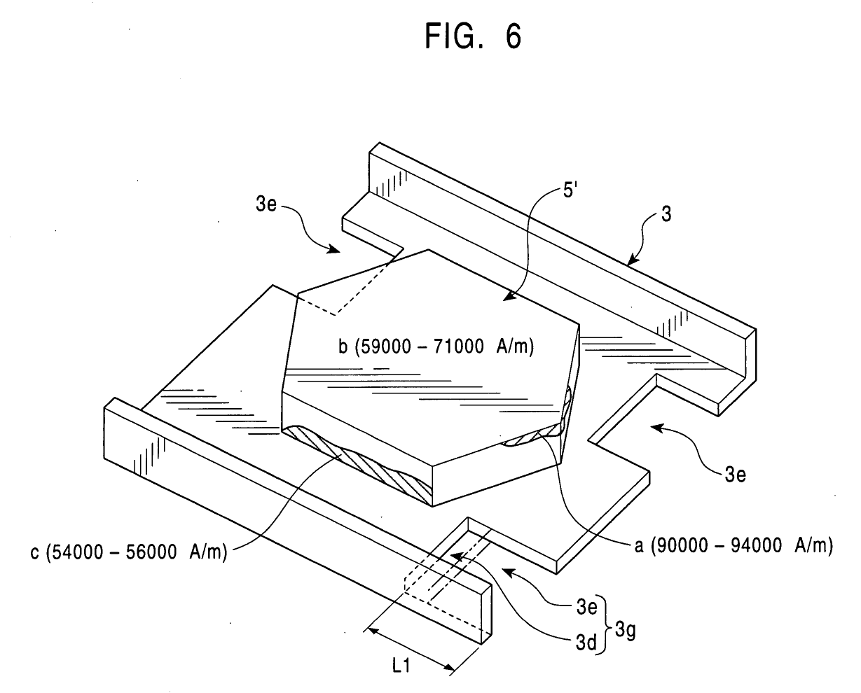

A 3.5-mm-square isolator having the same structure shown in FIGS. 1 to 4, except a hexagonal shape of a magnetic substrate, was formed. A distribution of a bias magnetic field applied to the magnetic substrate was measured when signals flow from the first input port P1 to the second output port P2. FIG. 6 shows the result of the measurement. FIG. 6 also shows the positions of the magnetic substrate 5′ and the lower yoke 3 used in the measurement.

The isolator 1 had a center frequency of 1.88 GHz.

The magnetic substrate 5′ was longitudinally about 1.5 mm and transversely about 1.8 mm in length, and 0.35 mm in thickness. The magnetic substrate 5′ was made of a hexagonal yttrium iron garnet (YIG) ferrite as shown in FIG. 6. The size of the notch 3d formed in the lower yoke 3, which is located under the hot side of the longitudinally mounted terminating chip resistor 13, was 0.6 mm by 0.2 mm. The size of the notch 3e, with which the third port P3 is engaged, was 0.6 mm by 0.4 mm. Therefore, the size of the notch 3g formed by joining the notches 3d and 3e was 0.6 mm by 0.6 mm. A distance L1 between the notch 3d and a corner of the lower yoke 3 was 0.6 mm. Both sizes of a notch 3e, with which the first port P1 was engaged, and a notch 3e, with which the second port P2 was engaged, were 0.6 mm by 0.4 mm.

The first line conductor 106 had a slit having a width of 330 μm and an effective line width of 590 μm. That is, a width of each conductor division was 130 μm. The first line conductor 106 was made of a copper film having a thickness of 40 μm. The second line conductor 107 had a slit having a width of 300 μm and an effective line width of 500 μm. That is, a width of each conductor division was 100 μm. The second line conductor 107 was made of a copper film having a thickness of 40 μm. The third line conductor 108 had a slit having a width of 1200 μm and an effective line width of 1500 μm. Widths of the conductor division 108b1 and the conductor division 108b2 were 100 μm and 200 μm, respectively. The third line conductor 108 was made of a copper film having a thickness of 40 μm. The common electrode 110 was longitudinally about 2000 μm and transversely about 3550 μm in length. The common electrode 110 was made of a copper film having a thickness of 40 μm.

A length L7, which is a length of overlap of the conductor division 106b1 of the eyebrow-shaped central portion 106E and the conductor division 107b1 of the eyebrow-shaped central portion 107E, was 28% of a length L4, which is a length of the central conductor on the first (the other) surface of the magnetic substrate 5′. The length of the parallel segments 36a was 46% of a length L7, which is a length of overlap of the conductor divisions. A length L8, which is a length of overlap of the conductor division 106b2 of the eyebrow-shaped central portion 106E and the conductor division 107b2 of the eyebrow-shaped central portion 107E, was 28% of the length L4. The length of the parallel segments 36b was 23% of the length L8.

The capacitance C1 of an electrode on the chip capacitor 111a, to which the first top conductor 106c is connected, was 13.0 pF. The capacitance C2 of an electrode on the chip capacitor 111b, to which the second top conductor 107c is connected, was 13.2 pF. The capacitance C3 of an electrode on the chip capacitor 12, to which the third top conductor 108c is connected, was 18.0 pF. The resistance R of the terminating resistor 13, to which the third top conductor 108c is connected, was 39 Ω.

A magnet (the permanent magnet 4) is transversely 2.5 mm, and longitudinally 2.0 mm in length.

### First Comparative Example

A similar isolator to that in the example 1 was formed. However, the isolator differs that in the first example in the following points: a terminating chip resistor is transversely mounted substantially parallel to a line M between the top conductor 106c of the first line conductor 106 and the top conductor 107c of the second line conductor 107, namely, a line between the first port P1 and the second port P2, and a 0.6-mm-square hole 3d′ is formed in the lower yoke at a position under a terminal electrode on the hot side of the transversely mounted terminating chip resistor.

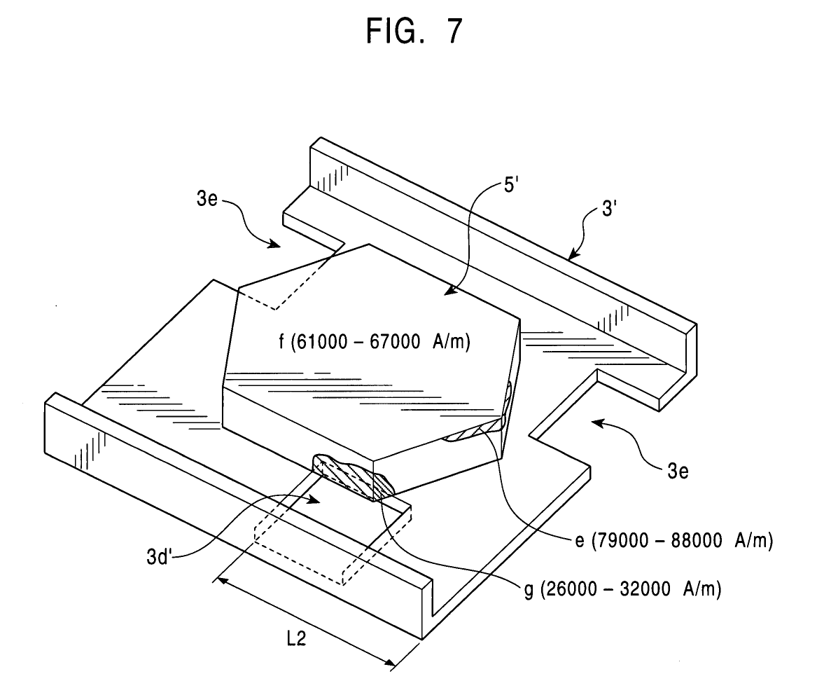

A distribution of a bias magnetic field applied to the magnetic substrate in the case where signals flow from the first input port P1 to the second output port P2 was measured. FIG. 7 shows the resultant distribution. FIG. 7 also shows positions of the magnetic substrate 5′ and the lower yoke 3′. A distance L2 between the hole 3d′ and a corner of the lower yoke 3′ was 1.2 mm.

As can be seen by the result shown in FIG. 7, in the isolator of the first comparative example, since the hole 3d′ was nearly in contact with the magnetic substrate 5′, a region g where a bias magnetic field was 26000 A/m to 32000 A/m was generated in the vicinity of the hole 3d′ in the magnetic substrate 5′. This value slightly exceeds a half of the value in the first example. In the isolator of the first comparative example, the bias magnetic field was 79000 A/m to 88000 A/m even in a region e where the bias magnetic field was a maximum. In contrast, at the center of the magnetic substrate 5′, a region f where the bias magnetic field was 61000 A/m to 67000 A/m was generated. This value is much greater than the value in the vicinity of the hole 3d′. Therefore, a whole bias magnetic field is non-uniform and unstable. This results in a large insertion loss of the isolator in the first comparative example.

As can be seen by the result shown in FIG. 6, in the isolator of the first example, since the notch 3d was positioned at a corner of the lower yoke 3, a region c where a bias magnetic field was 54000 A/m to 56000 A/m was generated even in the vicinity of a corner of the magnetic substrate 5′. This value is close to the value in the region b where a bias magnetic field was 59000 A/m to 71000 A/m at the center of the magnetic substrate 5′. Thus, a uniform and stable magnetic field is applied to the magnetic substrate 5′. This results in a low insertion loss of the isolator in the first example. The isolator in the first example generated a bias magnetic field of 90000 A/m to 94000 A/m in a region a, where a bias magnetic field became a maximum.

1. A nonreciprocal circuit device comprising:
a box-like yoke body comprising an upper yoke and a lower yoke, the yoke body accommodating:
a magnetic body;
three line conductors disposed on the magnetic body, the three line conductors being insulated with each other, any two of the line conductors functioning as input and output terminals, an end of the other line conductor being connected to a terminating chip resistor;
a capacitive element connected to an end of each line conductor; and
a magnet for applying a bias magnetic field to the magnetic body;
wherein, the terminating chip resistor is longitudinally disposed such that long sides of the chip resistor are substantially perpendicular to an imaginary line between ends of the input and output terminals, the end of the other line conductor is connected to a terminal electrode on a hot side of the terminating chip resistor, a terminal electrode on an earth side of the terminating chip resistor is directly connected to the lower yoke, and a notch or a hole is formed in the lower yoke at a position under the terminal electrode on the hot side of the terminating chip resistor.

2. A nonreciprocal circuit device comprising:
a box-like yoke body comprising an upper yoke and a lower yoke, the yoke body accommodating:
a magnetic body;
three line conductors disposed on the magnetic body, the three line conductors being insulated with each other, any two of the line conductors functioning as input and output terminals, an end of the other line conductor being connected to a terminating chip resistor;
a capacitive element connected to an end of each line conductor; and
a magnet for applying a bias magnetic field to the magnetic body;
wherein, a terminal electrode on a hot side of the terminating chip resistor is disposed at a corner of the lower yoke, the end of the other line conductor is connected to the terminal electrode on the hot side of the terminating chip resistor, a terminal electrode on an earth side of the terminating chip resistor is directly connected to the lower yoke, and a notch or a hole is formed at the corner of the lower yoke.

3. The nonreciprocal circuit device according to claim 1, wherein an overall size of the nonreciprocal circuit device is less than or equal to 3.5 mm square.

4. The nonreciprocal circuit device according to claim 1, wherein a length of the terminating chip resistor is 0.6 mm and a width of the terminating chip resistor is 0.3 mm.

5. The nonreciprocal circuit device according to claim 1, wherein the terminal electrode on the hot side of the terminating chip resistor and an inner surface of the lower yoke are insulated with a resin film.

6. A telecommunications apparatus comprising the nonreciprocal circuit device according to claim 1.
